(19) United States
(12) Patent Application Publication
(10) Pub. No.: US 2024/0383732 A1
(43) Pub. Date: Nov. 21, 2024

(54) METHOD FOR DEALING WITH OBSTACLES IN AN INDUSTRIAL TRUCK

(71) Applicant: Jungheinrich Aktiengesellschaft, Hamburg (DE)

(72) Inventors: Steffen Quickert, Wildeshausen (DE); Tony Altmann, Brokstedt (DE)

(21) Appl. No.: 18/658,199

(22) Filed: May 8, 2024

(30) Foreign Application Priority Data
May 16, 2023 (EP) 23173603.4

(51) Int. Cl. B66F 9/075; B66F 17/00

(52) U.S. Cl. CPC B66F 9/0755; B66F 9/07568; B66F 17/003

(57) ABSTRACT

An industrial truck comprises a sensor unit arranged in the main direction of travel of the industrial truck. The sensor is designed to be able to detect obstacles within a predetermined angular range. Described techniques include calculating a protection zone on the basis of a current speed and a current steering angle of the industrial truck and evaluating data supplied by the sensor unit within the protection zone. If an obstacle is detected in the protection zone, right and/or left steering angle differences are determined. The steering angle differences can be used to avoid the obstacle. In some cases, a predetermined measure for collision prevention is suppressed or initiated based on a combination of the steering angle differences and if a current steering angle to the right or to the left.

The present invention relates to a method for dealing with obstacles in an industrial truck comprising at least one sensor unit, which is arranged in the main direction of travel of the industrial truck and is designed to be able to detect obstacles within a predetermined angular range, and to an industrial truck which is designed to carry out such a method during the operation thereof.

During normal use of transport devices in logistics facilities, collisions between industrial trucks and warehouse equipment, between industrial trucks and other vehicles or between industrial trucks and people can occur with increased frequency, especially at peak times. One approach to counteracting such collisions can be to use a radio-based system that informs the industrial trucks of the presence of obstacles. However, it has been found that the sensor system currently in use leads to unnecessary braking and thus to a reduction in the efficiency of such vehicles.

Furthermore, to be able to also include objects and persons in the protection concept without such radio equipment, it is known to use sensor units in industrial trucks which check the surroundings thereof for obstacles and can be mounted and oriented on the industrial truck, particularly in the main direction of travel. In this case, the corresponding sensor units span what are known as protective fields, which often lie in horizontal planes just above the driving surface and the dimensions and orientations of which can in some cases be adapted to the current driving state of the industrial truck, for example oriented to a current steering angle and adapted in terms of their length to a current speed of the vehicle, in order to enable controlled braking whenever an obstacle is detected in such a protection zone.

If an object is thus detected by such a sensor unit, relevant information can be generated and/or a vehicle reaction or measure can be initiated. It is of course desirable that such a vehicle reacts or initiates a measure only if a collision is possible and probable, i.e., if an obstacle is located within the intended movement region of the vehicle. For this purpose, as already mentioned, the protection zone mentioned will depend on a current steering angle or a current direction of travel of the industrial truck in question, since it is precisely these parameters that determine the region of the driving surface that will soon be traveled over.

Accordingly, known systems for dealing with obstacles in industrial trucks use the steering angle determined by a corresponding sensor unit and the known current speed of the vehicle to predict the future travel path for a specific period of time and evaluate said travel path with regard to the presence of an obstacle. If there is an obstacle in this travel path, the system initiates the corresponding predetermined reaction or measure.

However, the problem here is that in certain driving situations, particularly in the case of human-driven industrial trucks, the operator may wish to initially drive toward an obstacle up to a certain distance, but to turn away from the obstacle in a controlled manner before a collision or to change the direction of travel of the vehicle in a way that means approaching the obstacle, but ultimately still constitutes planned and safe vehicle behavior.

An example of this can be the entry of such an industrial truck into an aisle, for example a rack aisle, inter alia. In such a case, when appropriately cornering to enter the aisle, pure extrapolation of the cornering movement into the future will cause the inside rack to be recognized as an obstacle and the collision avoidance system will be triggered accordingly, even though the situation is desired by the operator, is under control and therefore there is no danger under normal circumstances. Rather, it can be assumed that during such a maneuver, the operator of the industrial truck will correct the steering in good time, for example by straightening the vehicle as soon as it has turned onto a path parallel to both sides of the aisle, even though during the actual process of cornering or turning into the aisle, the pre-calculated path of the industrial truck will at least temporarily extend into the rack wall.

In order to now avoid triggering false positives in the detection of hazards and correspondingly activating countermeasures in such situations, which countermeasures could impair or irritate the operator of the vehicle when carrying out their work, there is a need to reliably recognize such operating situations and to provide a method by which corresponding predetermined measures for collision prevention or dealing with obstacles are initiated only in situations in which it is assumed that an operator is not in control of the industrial truck in the intended manner or is carrying out a dangerous driving maneuver in the vicinity of an obstacle.

In order to achieve the above-mentioned object and to provide a collision avoidance system or a method for dealing with obstacles which in fact only intervene or initiate predetermined measures in critical situations, the invention first and foremost proposes such a method comprising: detecting a current speed and a current steering angle to the right or left of at least one steered wheel of the industrial truck by means of a speed sensor or a steering angle sensor of the industrial truck; calculating a protection zone on the basis of the current speed and the current steering angle; evaluating the data supplied by the at least one sensor unit within the protection zone of the industrial truck; and, if an obstacle is detected in the protection zone, determining a corresponding right and a left steering angle difference with respect to the current steering angle, which difference can be used to avoid each obstacle, or determining a right or left steering angle difference with respect to the current steering angle, which difference can be used to avoid the obstacle, in the direction of straight-ahead travel, depending on whether a current steering angle is to the left or right; and suppressing at least one predetermined measure if a current steering angle is to the right and the current steering angle to the right is greater than or equal to the left steering angle difference, or a current steering angle is to the left and the current steering angle to the left is greater than or equal to the right steering angle difference, wherein the at least one predetermined measure is otherwise initiated.

The method can also comprise an assessment of whether there is a possible free travel path past the obstacle to the right or left on the basis of the current speed and a predetermined period of time, wherein the predetermined measure is suppressed only if in addition to the aforementioned conditions there is additionally a free left-hand travel path with a current steering angle to the right or if there is additionally a free right-hand travel path with a current steering angle to the left.

Thus, according to the invention, when an obstacle occurs in the protection zone defined on the basis of the current speed and the current steering angle of the vehicle, alternative paths are sought to the right and left of the obstacle, each of which paths corresponds to cornering at a constant steering angle. In this context, the protection zone corresponds first of all to a projected travel path of the industrial truck on the basis of the current speed and the current steering angle for a predetermined time and a possible free travel path may also have to have a specific length, which also depends on the current speed and accordingly on a predetermined period of time. In this context, it should also be noted that, among others, a wheel speed sensor can also be used as a speed sensor, or any other suitable device.

Furthermore, the right and left steering angle differences are used to calculate the minimum steering angle changes that an operator of the vehicle would have to make in order to be able to drive past the obstacle. Accordingly, the two steering angle differences to the right and to the left, as well as the information as to whether a free travel path has been found, act as input variables for determining whether the at least one predetermined measure is to be suppressed if an obstacle has in fact been detected in the protection zone, with the initiation of the measure initially being assumed to be the normal case.

In accordance with the logic implemented on this basis, actual hazardous situations are distinguished from situations in which an operator of the industrial truck is performing safe and controlled cornering and, in particular, it is possible to advantageously deal with cases in which an industrial truck is turning into an aisle and in the process the predicted path of the industrial truck briefly extends into a lateral boundary of the aisle, but it is still assumed that the operator will correct the vehicle in good time to drive straight ahead or something similar before a dangerous situation actually occurs. In other words, the logic according to the claims excludes from a measure only those cases in which the driver can avoid a detected obstacle by steering straight ahead from a cornering maneuver. However, the following atypical cases are not excluded:
if the driver is driving toward an obstacle: in this case the steering angle difference required to avoid the obstacle cannot be smaller than the current steering angle, which is already 0;
if the driver would have to steer beyond steering straight ahead to the other side in order to avoid the obstacle;
if the driver would have to steer harder into the bend to avoid the obstacle.

In these cases, the at least one predetermined measure can comprise reducing the current and/or maximum speed of the industrial truck. In this way, if an actual hazardous situation is detected, the vehicle can first be decelerated, which will automatically be reflected in the dimensions of the protective field in front of the vehicle, thus ensuring that the vehicle will in any case come to a stop before colliding with the obstacle, since the protective field will ultimately become shorter and shorter if deceleration is applied, until finally both the speed and the length of the protective field itself are reduced to zero.

Alternatively or additionally, the at least one predetermined measure can comprise issuing a corresponding message to an operator, for example an audible warning of a hazardous situation, or issuing a visual warning, such as a warning by flashing an LED or displaying a warning on a screen.

It would also be conceivable for the at least one predetermined measure to include a steering intervention to avoid the detected obstacle in the protection zone, which would require direct intervention in the control system of the industrial truck in question.

In connection with the above-mentioned examples of predetermined measures, it should also be noted that these can also be combined in stages, that is, for example, should a steering intervention be required below a predetermined threshold value, a warning could first be issued and, if the threshold value is exceeded, an intervention in the vehicle control system could be made, i.e., automatic braking and/or an evasive maneuver.

Furthermore, in the method according to the invention, determining the right and left steering angle difference and/or assessing the possible free travel path includes taking into account geometric dimensions of the industrial truck and/or of a load carried thereby. This allows an as accurate as possible evaluation or determination of steering angle differences and travel paths to be carried out, although, alternatively, a collision zone defined independently of the actual dimensions of the industrial truck could also be assumed, and could, for example, include additional tolerances or simplifications of the vehicle geometry.

According to a second aspect, the present invention relates to an industrial truck which is designed to carry out a method of the above-described type during the operation thereof, comprising: a vehicle body; at least one sensor unit, which is arranged in the main direction of travel of the industrial truck and is designed to be able to detect obstacles within a predetermined angular range; a speed sensor and a steering angle sensor; and a control unit which is designed to obtain data from the speed sensor and the steering angle sensor, calculate a protection zone, determine a right and a left steering angle difference with respect to the current steering angle, which difference can be used to avoid each obstacle detected in the protection zone, assess, if necessary, whether there is a possible free travel path past the obstacle to the right or left, and decide on the basis of the presence of a free travel path and the steering angle differences whether or not at least one predetermined measure according to the above-described method should be initiated.

The at least one sensor unit can comprise, for example, a LIDAR unit and/or the industrial truck can be a manually driven industrial truck, i.e., an industrial truck that is controlled directly by an operator. Although such a method according to the invention could in principle also be used in autonomous or semi-autonomous vehicles, the underlying concept here—of intentionally approaching an obstacle before appropriately counter-steering—is of less significance in such vehicles, since the intended travel path of the corresponding control unit should always be known when planning a travel path in an autonomous vehicle.

Further features and advantages of the present invention will become even more apparent from the following description of an embodiment thereof, and in particular of different operating situations for a corresponding industrial truck, when considered together with the accompanying drawings. In the figures, in detail:

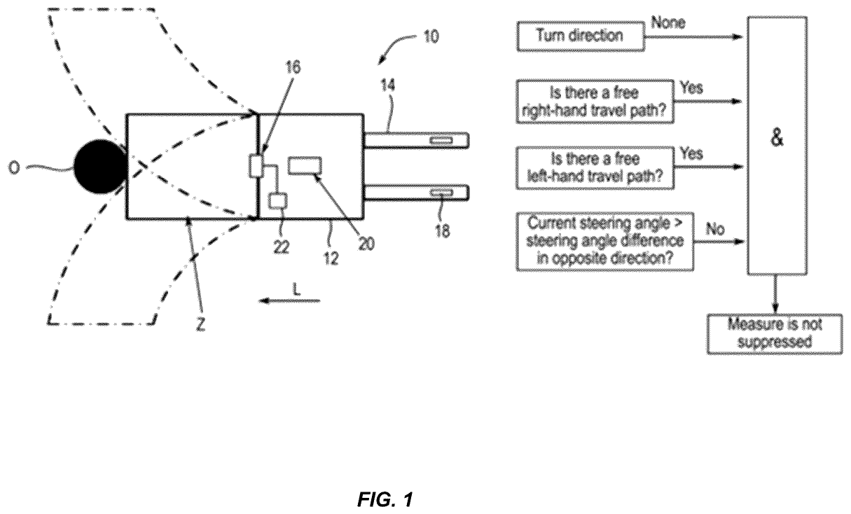

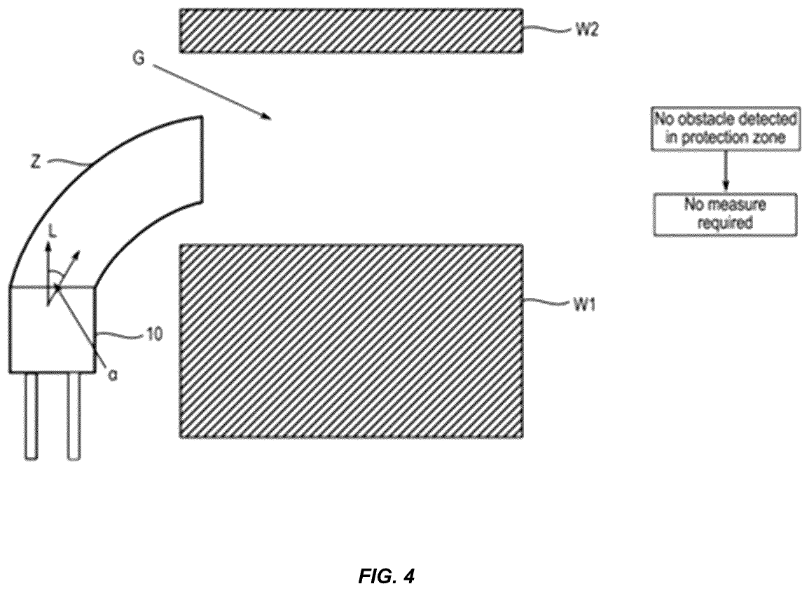

FIGS. 1 to 3 are explanatory schematic diagrams illustrating possible operating situations during operation of an industrial truck according to the invention; and FIGS. 4 to 8 are explanatory schematic diagrams illustrating operating situations of the industrial truck from FIGS. 1 to 3 when entering an aisle.

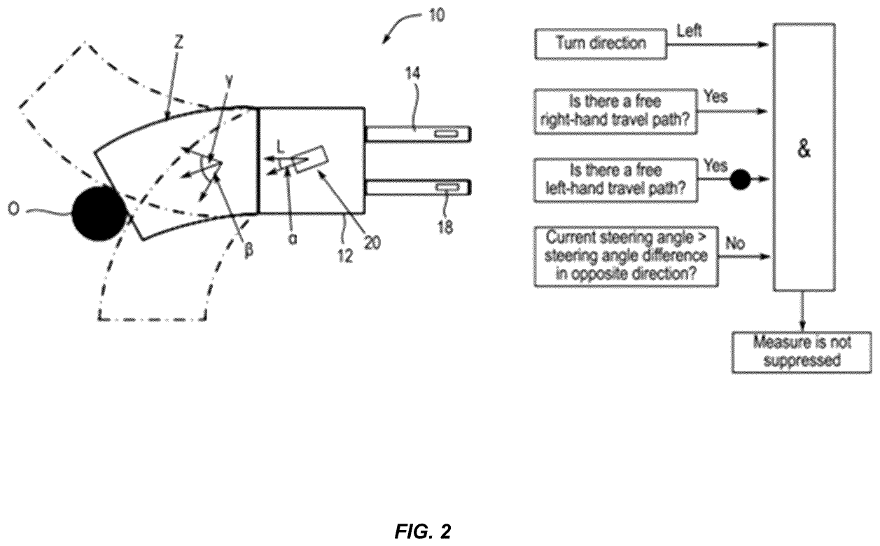

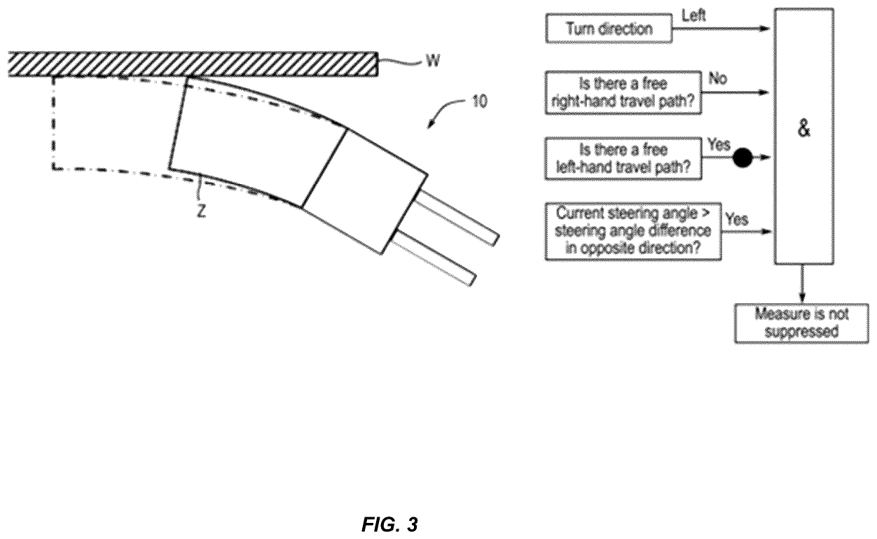

Firstly, FIGS. 1 to 3 show different operating situations of an industrial truck 10 according to the invention in a schematic plan view; in FIGS. 1 and 2 there is a free-standing obstacle O directly in front of or at an angle in front of the industrial truck 10, while in FIG. 3 there is a wall W in the vicinity of the industrial truck 10 or on its current extrapolated path.

The industrial truck 10 has a vehicle body 12 and a load-handling means 14 on which a load (not shown here) can be transported. In addition, the industrial truck 10 comprises a sensor unit 16, which is arranged at the front of the industrial truck 10 in accordance with the main direction of travel L and can, for example, cover an angular range of at least 180°. Furthermore, the industrial truck 10 comprises a pair of non-steered wheels 18, which are located in the region of the load-carrying means 14, and a steered drive wheel 20. In the case shown here, the industrial truck 10 is a manually driven industrial truck which is intended and designed for transporting objects in logistics facilities. For this purpose, the industrial truck further comprises a control unit 22 (shown only schematically) as well as speed sensors and steering angle sensors (not shown further) which supply their data to the control unit 22 in a similar manner to the sensor unit 16. For reasons of clarity, some of the components of the industrial truck 10 mentioned here are only shown in some of the figures, but it goes without saying that the industrial truck 10 is the same in all the figures.

Furthermore, FIGS. 1 to 3 each show a protection zone Z of the industrial truck 10, which zone is determined on the basis of the current speed of the industrial truck 10 and the current steering angle α of the vehicle 10 in relation to the main direction of travel L. The industrial truck 10 in FIG. 1 is currently traveling straight ahead, and therefore the steering angle α is currently 0°, while in FIGS. 2 and 3 it is making left turns at a specific current steering angle α.

Furthermore, in each of FIGS. 1 to 3, possible free travel paths or avoidance paths past the obstacle O or wall W are shown by dot-dashed lines and allow the corresponding obstacle O or wall W to only just be passed at a minimum distance. Whereas in FIGS. 1 and 2 there are free left-hand and right-hand travel paths, in the operating situation shown in FIG. 3 there is only a free left-hand travel path, since the wall W does not allow the vehicle to avoid it to the right. The corresponding free left-hand and right-hand travel paths correspond to right and left steering angle differences with respect to the current steering angle α that can be used to just avoid the obstacle in each case; these differences are labeled β and γ. Accordingly, it should be noted that the two angles β and γ are each to be considered in relation to the current steering angle α and this in turn is to be considered in relation to the main driving direction or straight-ahead driving direction L.

The method according to the invention can now be used to determine whether a predetermined measure for avoiding the obstacle O or the wall W is to be initiated, i.e., in particular reducing the current and/or maximum speed of the industrial truck, issuing a corresponding message to the operator of the industrial truck 10 or even an automated steering intervention.

In the context of the method according to the invention, it is assumed in all situations from FIGS. 1 to 3 that the initiation of an appropriate predetermined measure will be necessary, since in FIGS. 1 and 2 the vehicle is being driven directly toward the free-standing obstacle O and accordingly no attempt is being made to avoid it, whereas in FIG. 3 the chosen steering angle is too small and therefore a collision with the wall W must be assumed.

The corresponding input data for determining whether the at least one predetermined measure is to be initiated and the procedure based thereon are also shown schematically in FIGS. 1 to 3 by means of a diagram, i.e., in particular whether a right or left turn is being taken, whether a right and/or left avoidance path has been found, and whether a corresponding steering angle is greater or smaller than an associated steering angle difference. The corresponding evaluations each show that the at least one predetermined measure does not have to be suppressed, since the combination of conditions according to the invention whereupon the corresponding measure is to be initiated have not been fulfilled.

FIGS. 4 to 8, in contrast, show operating situations in which the industrial truck 10 is entering an aisle A that is bounded on its right and left sides by a right-hand wall W1 and a second wall W2. In FIG. 4, the industrial truck 10 is just beginning to enter the aisle A, i.e., the steered wheel 20 currently has a steering angle that will cause the industrial truck 10 to make a right turn into the aisle A. However, since currently no obstacle is present in the protection zone Z, there is no need to check whether a predetermined measure for dealing with obstacles should be initiated in this case either.

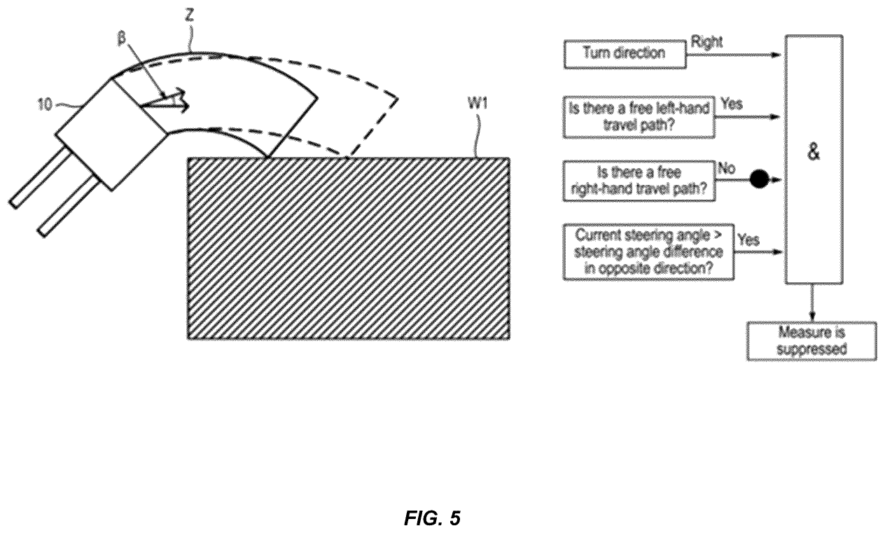

In contrast, in FIG. 5 the industrial truck 10 has already passed through some of the curved path to enter the aisle A and the protective field Z is coming into contact with the right-hand wall W1 of the aisle A for the first time at this moment. A steering angle α of 30° is assumed in FIG. 5, while at the same time it is determined that a left-hand avoidance path exists and a left steering angle difference β only has to be 10°, as indicated by the dashed outline in FIG. 5. Accordingly, the current steering angle α to the right is greater than the determined left steering angle difference β and the initiation of the predetermined measure is suppressed according to the invention, since this is by definition a normal operating situation of the industrial truck 10 and it is assumed that the operator of the industrial truck 10 will re-straighten the steering in good time so that there will be no collision with the wall W1.

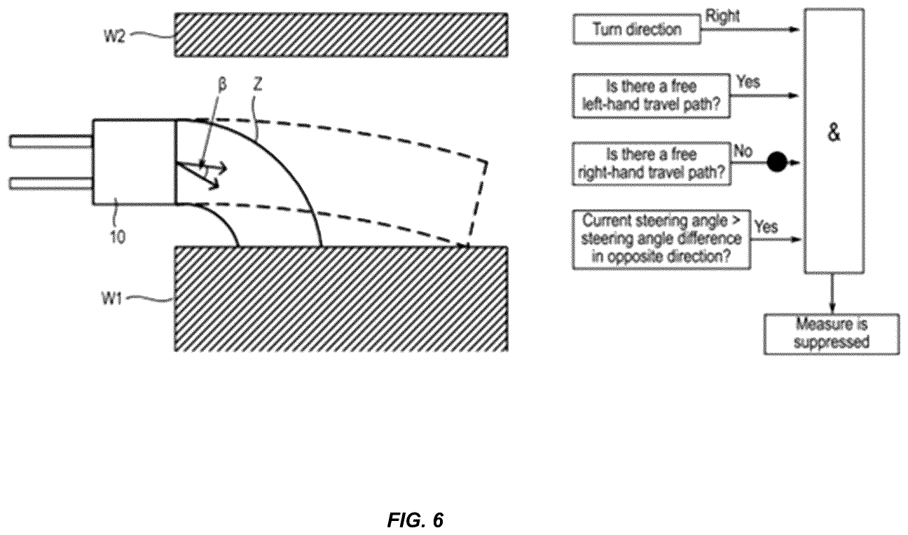

In the situation shown in FIG. 6, too, in which the industrial truck 10 is now aligned substantially in parallel with the walls W1 and W2 with respect to its main direction of travel L, the at least one predetermined measure remains suppressed, since the determined left avoidance angle β of 20° is still smaller than the current steering angle α of 30° and consequently the conditions for suppressing the predetermined measure are still fulfilled.

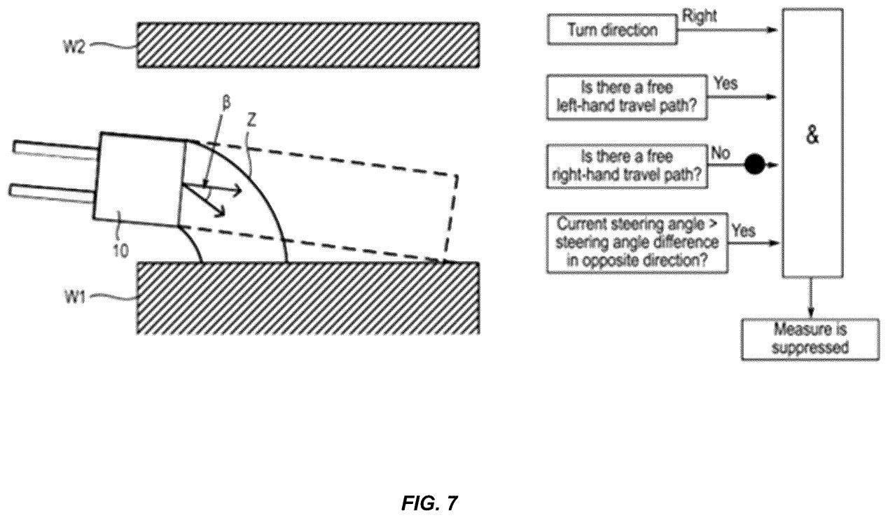

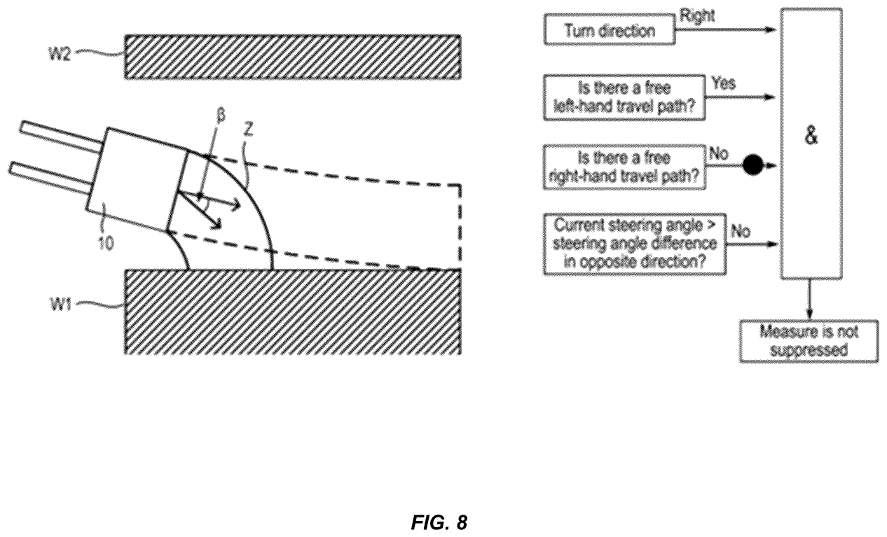

In contrast, FIG. 7 now shows the marginal case in which the current steering angle α is still 30°, but the left avoidance angle β is also just 30°. Consequently, if the operator of the industrial truck 10 does not immediately initiate a countermeasure in this situation, in particular counter-steering to the left, the case shown in FIG. 8 will occur, in which the left avoidance angle β is now 35° while the current steering angle α is still 30° so that the condition for suppressing the at least one predetermined measure is no longer being met at this point and said measure will therefore be initiated.

Accordingly, it can be understood from FIGS. 4 to 8 that a normal controlled entry into an aisle A is possible without the at least one predetermined measure being initiated, whereas the predetermined measure is initiated as of a certain point in time only if the operator of the industrial truck 10 fails to re-straighten the vehicle in good time or to counter-steer, this point in time depending on the current speed of the industrial truck 10 since said speed is factored into the dimensions of the protection zone Z as well as into the determination of the free travel path to the left.

1-9. (canceled)

10. A method for dealing with obstacles in an industrial truck, the method comprising:
detecting, via a speed sensor of the industrial truck, a current speed of the industrial truck;
detecting, via a steering angle sensor of the industrial truck, a current steering angle of the industrial truck, the current steering angle determined with respect to a right side or a left side of at least one steered wheel of the industrial truck;
calculating a protection zone based on the current speed and the current steering angle;
receiving, from at least one sensor unit included in and arranged in a main direction of travel of the industrial truck, data from within the protection zone;
determining, based on evaluation of the data received from the at least one sensor unit, that an obstacle is in the protection zone; and
responsive to determining that the obstacle is in the protection zone:
determining, with respect to the current steering angle, a right steering angle difference and a left steering angle difference;
suppressing at least one predetermined measure for collision prevention if one of the following conditions is met:
i) the current steering angle is with respect to the right side of the at least one steered wheel and is greater than or equal to the left steering angle difference, or
ii) the current steering angle is with respect to the left side of the at least one steered wheel and is greater than or equal to the right steering angle difference; and
initiating the at least one predetermined measure for collision prevention responsive if neither of the conditions is met.

11. The method according to claim 10, further comprising:
determining, based on the current speed and a predetermined period of time, that there is a possible free travel path past the obstacle; and
suppressing the at least one predetermined measure for collision prevention only if one of the following additional conditions is met:
i) the current steering angle is with respect to the right side of the at least one steered wheel and the possible free travel path is a left-hand travel path, or
ii) the current steering angle is with respect to the left side of the at least one steered wheel and the possible free travel path is a right-hand travel path.

12. The method according to claim 10, wherein the at least one predetermined measure for collision prevention comprises one or more of:
reducing the current speed of the industrial truck, or
reducing a maximum speed of the industrial truck.

13. The method according to claim 10, wherein the at least one predetermined measure for collision prevention comprises issuing a message to an operator of the industrial truck.

14. The method according to claim 10, wherein the at least one predetermined measure for collision prevention comprises a steering intervention to avoid the obstacle.

15. The method according to claim 10, wherein determining the right steering angle difference or the left steering angle difference includes determining one or more of i) a geometric dimension of the industrial truck or ii) a load carried by the industrial truck.

16. The method according to claim 10, further comprising:
determining a possible free travel path past the obstacle, wherein determining the possible free travel path includes determining one or more of i) a geometric dimension of the industrial truck or ii) a load carried by the industrial truck.

17. The method according to claim 10, wherein the at least one sensor unit comprises a laser imaging detection and ranging unit (“LiDAR unit”).

18. The method according to claim 10, wherein the industrial truck is a manually driven industrial truck.

19. An industrial truck comprising:
a vehicle body,
at least one sensor unit that is arranged in a main direction of travel of the industrial truck, the at least one sensor unit configured for detecting an obstacle within a predetermined angular range,
a speed sensor,
a steering angle sensor, and
a control unit, the control unit configured for:
receiving data from the speed sensor and the steering angle sensor;
calculating a protection zone;
determining, with respect to a current steering angle, a right steering angle difference and a left steering angle difference;
determining that there is a possible free travel path past the obstacle to a right side of the obstacle or a left side of the obstacle; and
initiating at least one predetermined measure for collision prevention responsive to determining i) the right steering angle difference and the left steering angle difference and ii) that the possible free travel path is to the right side or the left side of the obstacle.

20. The industrial truck according to claim 19, wherein the at least one sensor unit comprises a laser imaging detection and ranging unit (“LiDAR unit”).

21. The industrial truck according to claim 19, wherein the industrial truck is a manually driven industrial truck.

22. The industrial truck according to claim 19, wherein the control unit is further configured for, responsive to detection of an additional obstacle:
suppressing an additional predetermined measure for collision prevention if one of the following conditions is met:
i) an additional current steering angle is with respect to a right side of a steered wheel of the industrial truck and is greater than or equal to the left steering angle difference, or
ii) the additional current steering angle is with respect to a left side of the steered wheel of the industrial truck and is greater than or equal to the right steering angle difference.

23. The industrial truck according to claim 22, wherein the control unit is further configured for:
determining, based on a current speed and a predetermined period of time, that there is an additional possible free travel path past the additional obstacle; and
suppressing the additional predetermined measure for collision prevention only if one of the following additional conditions is met:
i) the additional current steering angle is with respect to the right side of the steered wheel of the industrial truck and the additional possible free travel path is a left-hand travel path, or
ii) the additional current steering angle is with respect to the left side of the steered wheel of the industrial truck and the additional possible free travel path is a right-hand travel path.

24. The industrial truck according to claim 19, wherein the at least one predetermined measure for collision prevention comprises one or more of:
reducing a current speed of the industrial truck, or
reducing a maximum speed of the industrial truck.

25. The industrial truck according to claim 19, wherein the at least one predetermined measure for collision prevention comprises issuing a message to an operator of the industrial truck.

26. The industrial truck according to claim 19, wherein the at least one predetermined measure for collision prevention comprises a steering intervention to avoid the obstacle.

27. The industrial truck according to claim 19, wherein determining the right steering angle difference or the left steering angle difference includes determining one or more of i) a geometric dimension of the industrial truck or ii) a load carried by the industrial truck.

28. The industrial truck according to claim 19, wherein determining the possible free travel path includes determining one or more of i) a geometric dimension of the industrial truck or ii) a load carried by the industrial truck.
